(19) United States
(12) Patent Application Publication
(10) Pub. No.: US 2008/0029133 A1
(43) Pub. Date: Feb. 7, 2008

(54) Portable cleaning system and method

(76) Inventor: Shawn E.W. Kunkle, Bradford, OH (US)

Correspondence Address: Raymond M. Galasso;Galasso & Associates LP, P.O. Box 26503, Austin, TX, 78755-0503, US

(21) Appl. No.: 11/352,779

(22) Filed: Feb. 13, 2006

(51) Int. Cl. B08B 3/00

(52) U.S. Cl. 134/113; 134/123

(57) ABSTRACT

A portable cleaning system and method of use are provided. In one form, a portable cleaning system includes an elongated housing including openings at non-contiguous opposing ends and an internal spray system operable to spray contents placed within the housing along a three hundred and sixty (360) degree radius at multiple stages within the housing. The portable cleaning system includes a plurality of elongated pieces of material hung vertically and substantially covering the non-continguous opposing ends. The plurality include elongated pieces of material operable to reduce an over spray from exiting the housing. The portable cleaning system further includes an automated transfer system operable to transfer a plurality of carts along the length of the housing.

### FIELD OF THE DISCLOSURE

The invention generally relates to sanitization, and more particularly to a portable cleaning system and method of use.

### BACKGROUND

An increasing number of people are becoming concerned with the prevention of health issues, rather than merely on the treatment and cure of problems once they occur. An indication such a concerns is evidenced by the increasing number of people are eating healthy, engaging in stress reduction activities such as yoga, and seeing doctors regularly for checkups. One way this concern for prevention is manifested is by the increased concern for personal sanitation. Instead of merely using soap, people are using antibacterial soaps. Instead of occasionally cleaning showers and tubs as time permits, people are increasingly applying mold and mildew killing agents at the end of the shower or bath.

Another interesting trend is the increase in liability lawsuits against companies perceived to have deep pockets. A person who wouldn't litigate against a friend when an accident occurs to the person at that friend's house might be more than willing to file a suit against a company such as Wal-Mart, if even a hint of negligence is protected. Even smaller companies are at risk of litigation, and the risk for them is even greater, as most small companies don't have the financial wherewithal to withstand a negligence judgment. The intersection of these two trends has caused an increased focus on sanitation and disease prevention at companies worldwide. Witness the increased focus on the prevention of mad cow disease.

An overlooked source of unsanitary conditions is the conventional shopping cart. In a given day, a single grocery shopping cart may be exposed to hundreds of germ-bearing people, raw meats spilling from torn packages, or other unsanitary conditions. A disease outbreak could cost a company millions in damages and lost reputation. What is needed is a way to clean, rinse, sanitize, and dry shopping carts, without requiring the carts to be removed from use and taken to a washing area.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a side perspective view of a portable cleaning system in accordance with one aspect of the present invention; and

FIG. 2 illustrates an internal spray system provided within a portable cleaning system according to one embodiment of the invention.

### DESCRIPTION

A portable cleaning system and method of use are provided. In one form, a portable cleaning system includes an elongated housing including openings at non-contiguous opposing ends and an internal spray system operable to spray contents placed within the housing along a three hundred and sixty (360) degree radius at multiple stages within the housing. The portable cleaning system further includes a plurality of elongated pieces of material hung vertically and substantially covering the non-contiguous opposing ends wherein the plurality of elongated pieces of material are operable to reduce an over spray from exiting the housing. The portable cleaning system further includes an automated transfer system operable to transfer a plurality of carts along the length of the housing.

According to another aspect of the invention, a portable cleaning system includes a housing including a length and a first and second openings at non-contiguous opposing ends and a high-pressure internal spray system operable to spray contents placed along a first stage within the housing. The high-pressure internal spray system is operable to spray along a three hundred and sixty (360) degree radius. The portable cleaning system further includes a low-pressure internal spray system operable to spray contents placed at a second stage within the housing and operable to spray along a three hundred and sixty (360) degree radius. A cart transport system is also provided and includes a front loading platform, a rear unloading platform, and a track there between, the cart transport system operable to transfer a plurality of carts along the housing.

According to a further aspect of the invention, a portable cleaning system is provided and includes a rectangular housing enclosed along four contiguous sides including a first opening providing an entry and a second opening providing an exit and a high-pressure internal spray system operable to spray contents placed within the housing along a three hundred and sixty (360) degree radius. The portable cleaning system further includes a low-pressure internal spray system operable to spray contents placed within the housing along a three hundred and sixty (360) degree radius and a loading platform coupled to the entry and operable to assist with loading a plurality of carts into the housing. An exit platform is coupled to the exit of the portable cleaning system and is operable to assist with unloading the plurality of carts from the housing. The portable cleaning system further includes two (2) tracks running along a bottom of the housing and extending from the entry to the exit, the two (2) tracks including a portion of the low-pressure internal spray system and the high-pressure internal spray system positioned between the two (2) tracks.

The apparatus further includes a plurality of elongated pieces of material hung vertically and substantially covering the non-contiguous opposing ends. These pieces of material serve to reduce over spray from the nozzles inside the housing.

The apparatus includes a loading platform coupled to each of the openings. The loading platforms assist with loading carts into and unloading carts from the cleaning system. The cleaning system includes a low-pressure line supplying a cleansing agent to the nozzles substantially along the front of the housing, a high-pressure line supplying a rinsing agent to the nozzles substantially along the center of the housing, and a low-pressure line supplying a sanitizing agent to the nozzles substantially along the rear of the housing. The cleaning system further includes a suction tube connected substantially to the rear of the housing. This tube enables drying of the contents of the housing. The housing is substantially metal. In one embodiment, the housing is sized to enclose and wash shopping carts. The system includes operating states of wash cycle, rinse cycle, sanitize cycle, and dry cycle. In one embodiment, the closed contiguous sides of the housing comprise a polycarbonate material. This material, being softer and lighter than the metal of the housing, could require less effort to move the portable system than an all metal system. The polycarbonate sides could also be removed for storage, allowing the system to be stored in a much smaller size than the system would require fully assembled.

According to another aspect of the invention, a portable cleaning system is disclosed. The system includes a rectangular housing including a length and enclosed along four contiguous sides including openings at the non-contiguous ends. The system further includes a high-pressure internal spray system and a low-pressure internal spray system. The housing includes a plurality of elongated pieces of material hung vertically and substantially covering the non-contiguous opposing ends of the housing, serving to reduce an over spray from exiting the housing. The housing further includes a loading platform coupled to a portion of one of the openings and operable to assist with loading a cart into the rectangular housing. In one embodiment, the loading platform is coupled to the front opening of the housing, enabling carts to enter the cleaning system. In one embodiment, the loading platform is coupled to the rear opening of the housing, enabling carts to exit the cleaning system. The portable cleaning system spray nozzles locating inside the housing, along the top, bottom, and both sides of the enclosed housing. The system further includes a detachable drainage tray running substantially the length and width of an undercarriage of the housing.

According a further aspect of the invention, a portable cleaning system is disclosed. The system includes a rectangular housing including a length and enclosed along four contiguous sides including openings at the non contiguous ends. The system further includes a high-pressure internal spray system and a low-pressure internal spray system. The housing includes a plurality of elongated pieces of material hung vertically and substantially covering the non-contiguous opposing ends of the housing, serving to reduce an over spray from exiting the housing. The system further includes a loading platform coupled to the entry to assist with loading a plurality of carts within the housing and an exit platform coupled to the exit to assist with unloading the plurality of carts from the housing. The system includes two metallic ramps coupled to the entry and exit and spaced to accommodate unloading and unloading the plurality of carts. The system further includes a first low-pressure connection coupled to an interior of the housing and located approximately toward the front of the housing, operable to spray a cleaning agent. The system further includes a high-pressure connection coupled to an interior of the housing and located approximately toward a middle portion of the housing, operable to spray a cleaning agent. The system further includes a second low-pressure connection coupled to an interior of the housing and located approximately toward a rear portion of the housing, operable to spray a rinsing agent. The system further includes a vacuum dryer connection coupled to an interior of the hosing and located approximately toward a rear portion of the housing, operable to provide warm air along the rear portion of the housing.

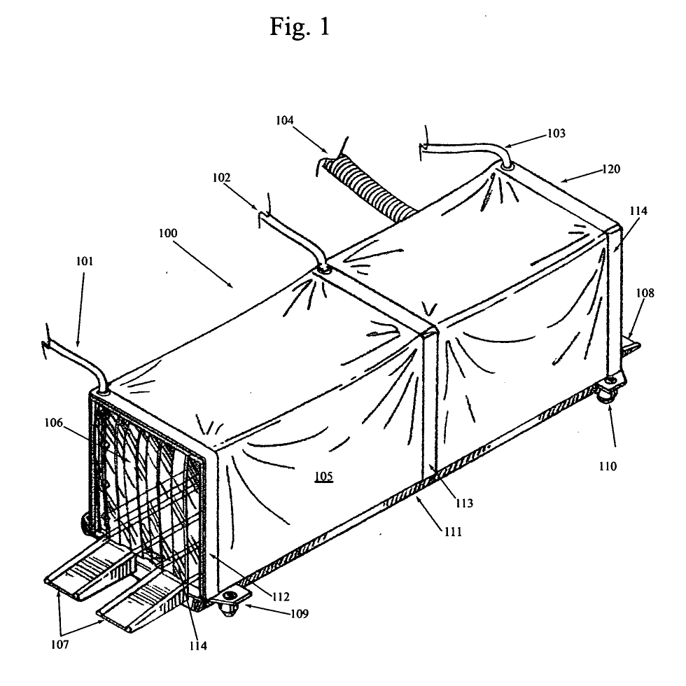

FIG. 1 illustrates a front perspective view of a portable cleaning system according to one embodiment of the invention. Portable cleaning system, illustrated generally at 100, includes a housing 105 including a front opening or entry 106 and an rear open or exit 114. Entry 106 includes a loading platform 107 coupled to entry 106 and aligned with a transport track 114 operable to transport a cart along housing 105. Track 114 allows for transporting carts and may include a track defined with a region for positioning wheels of a cart and restricting wheels from deviating from track 114. In another form, track 114 may be a belt driven track that includes a movable track that traverses from entry 106 to exit 114 and may include one or more wheels coupled to the movable track and operable to engage a portion of a cart wheel when contacted. Other belt transfer systems may also be used as needed. Unloading platform 108 is provided at exit 120 and spaced to accommodate unloading a plurality of carts (not expressly shown). Loading platform 107 and unloading platform 108 are provided at an angle or grade sufficient to load and unload carts within portable cleaning system 100. Loading platform 107 and unloading platform 108 may be formed of various types of materials including metal such as aluminum, stainless steel, etc., durable plastics, or other types of material and may be removed for storage or cleaning as needed.

Portable cleaning system 100 further includes a first low-pressure fluid distribution line 101 positioned toward a front portion of portable cleaning system 100 operable to be used to provide a first process for cleaning a cart. Portable cleaning system 100 further includes a high-pressure fluid distribution line 102 operable to be used to provide a second process for cleaning a cart. A drying or air line 104 is coupled to portable cleaning apparatus 100 and provides air for drying a cart during a dry process. Portable cleaning apparatus 100 further includes a second low-pressure line 103 operable to be used to provide a second process for cleaning a cart. Each line may include a quick disconnect valve for removing and connecting each line to portable cleaning apparatus 100 and for allowing for easy portability of portable cleaning apparatus 100. A control valve may also be coupled to each line to allow for controlling when a fluid is distributed within portable cleaning apparatus 100. In one embodiment, a control valve may include an electronic solenoid that may be activated and deactivated as needed when a cart traverses within housing 105. For example, a control circuit may be coupled to each control valve and may also be coupled to one or more stage sensors provided along housing 105 and proximally located to each line. As a cart traverses along housing 105, a sensor may detect the cart (or absence of a cart) and activate and/or deactivate a solenoid for each line to enable and disable distribution of fluids. Various types of sensors, solenoids, control valves, etc. may be employed as needed.

During use, a cart or plurality of carts are loaded into portable cleaning apparatus 100 using entry ramps 107. Low-pressure fluid distribution line 101 provides a liquid cleaning agent to a releasable coupling line (not expressly shown). Various types of cleaning agents may be used including liquid cleaning agents. For example, low-pressure fluid distribution line 101 may be coupled to a reservoir or supply system housing a cleaning agent such as a soap and degreasing agent having a temperature of approximately seventy-five (75) degrees and a pump (not expressly shown) may be used to transport a cleaning agent along low-pressure supply line 101 to cover a cart placed within housing 105.

As a cart is transported along portable cleaning system 100, high-pressure fluid distribution line 102 coupled to high pressure manifold 113 provides a rinsing agent at a temperature of approximately one hundred sixty (160) degrees to provide a rinse process to rinse a cart as a cart passes or is displaced along housing 105. For example, high-pressure fluid distribution line 102 provides a rinsing agent to high-pressure manifold 113 which disburses a rinsing agent using nozzles (not expressly shown) provided around three-hundred sixty (360) degrees of housing 105. In one embodiment, high-pressure fluid distribution line 102 is supplied by a vehicle, truck, trailer, etc. housing a pump and rinsing agents (not expressly shown) for use with portable cleaning system 100.

Portable cleaning system 100 further includes second low-pressure fluid distribution line 103 coupled to second low pressure manifold 114 neat exit 120. In one form, fluid distribution line 103 dispenses a sanitizing agent that complies with the Environmental Protection Agencies certified sanitizer code of 21 CFR 178.1010 to nozzles (not expressly shown) substantially at the rear of system 100 at a pressure of approximately forty-five (45) psi. Fluid distribution line 103 may provide a chlorine or chlorine-based solution of fifty (50) mg/l with a PH of ten and a temperature of approximately one hundred degrees for approximately seven (7) seconds. Other types of sanitizers may also be used at various temperatures and various periods of time. After a sanitizing agent is applied, the sanitizing agent may be allowed to air dry onto the cart prior to use.

In one embodiment, portable cleaning system 100 further includes vacuum dryer connection port 104 attached toward a rear portion of portable cleaning system 100. In one form, vacuum dryer connection port 104 provides warm air to provide a drying cycle for drying a cart when displaced along housing 105 near dryer connection port 104.

Portable cleaning system 100 further includes a plurality of elongated pieces of material 106 hung vertically along front opening 112 and rear opening 120 (not expressly shown) substantially covering front opening 112 and rear opening. Material 106 serves to substantially reduce over spray from internal nozzles (not expressly shown). In one form material 106 is formed from a flexible plastic and allows items to be loaded and unloaded within portable cleaning system 100 without requiring use of a door, etc to provide access. In one form, material 106 is substantially transparent, allowing easy viewing of the contents of portable cleaning system 100.

In one embodiment, portable cleaning system 100 includes a drainage tray 111 sized to run substantially along the undercarriage of housing 105. Drainage tray 111 captures waste draining from the cleaning system and in one form is removable, providing environmental safety by preventing the waste from running off during use. For example, wastewater may be captured using drainage tray 111 and may be removed at a later time to properly and safely disposing of the waste. In another embodiment, drainage 111 may be coupled to a wastewater or biohazardous collection container (not expressly shown) which may collect the wastewater and allow for disposal at a later time. In one embodiment, drainage tray 111 may include a filtration system (not expressly shown) to capture particles that may clog drainage tray.

In one embodiment, portable cleaning system 100 includes wheels 109 and 110 coupled to housing 105 to allow for portability of cleaning system 100. For example, a grocery store may make use of portable cleaning system 105 may stow portable cleaning system 105 until needed.

Portable cleaning system 100 includes housing 105 formed from a light, durable material, and may be provided in various shapes. For example, housing 105 may be formed of a polycarbonate material in a substantially square or rectangular shape however in other embodiments, housing 105 may include a circular or oval shaped housing or any other shape or combination of shapes. Polycarbonate is may be formed as a lightweight material reducing the overall weight of portable cleaning system 100, enhancing portability.

In one embodiment, one or more side of housing 105 may removable/replaceable if broken, damaged, or disfigured. For example, housing 105 include sides that may be removed, allowing for portable cleaning system 100 to be broken down or disassembled into component parts and stored or transported to a new location. For example, portable cleaning system 100 may be well suited for portability to several retail locations during off or closed hours allowing and may be used by a third party to sanitize or clean carts at several locations. In one embodiment, portable cleaning system 100 may provided as a part of a trailer which may be towed from location to location as needed. Additionally, housing 105 may be formed from a material that may be expanded and collapsed as needed.

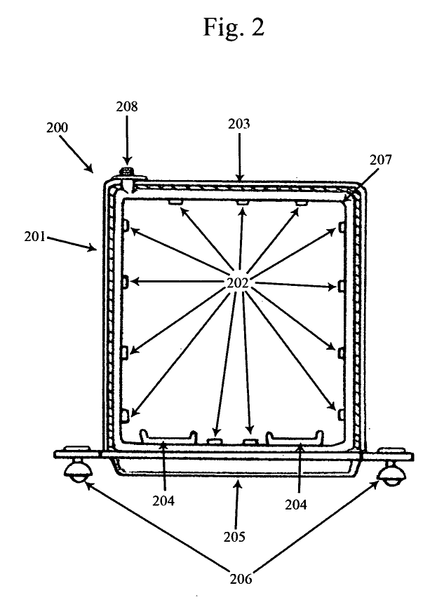

FIG. 2 illustrates an internal spray system provided within a portable cleaning system according to one embodiment of the invention. A front perspective view of a portable cleaning system, illustrated generally at 200, includes housing 201 having an internal spray system 203. Portable cleaning system 200 includes a cart transfer system or tracks 204 running at the bottom of housing 201 and positioned substantially along a length of housing 201 (not expressly shown). Tracks 204 are used to transport or roll carts through portable cleaning system 200. Tracks 204 include a width and height sufficient to keep shopping carts from inadvertently contacting hosing 201 or internal spray system 203. In one embodiment, a width between tracks 204 may be widened or shortened to accommodate various types of carts. For example, tracks 204 may be expanded to a specific width to accommodate various types of carts or other types of rolling equipment that may benefit from cleansing and sanitization. Additionally, width of each track 204 may be varied as needed and in one embodiment may be removed and replaced as needed to accommodate various types of carts.

Portable cleaning system 200 further includes a drainage tray 205 coupled to undercarriage of housing 201. Drainage tray 205 captures wastewater provided by use of internal spray system 203 and may include a trap or filter to capture large objects. Drainage tray 205 prevents the waste from exiting housing 201 until an operator remove wastewater and in one form, drainage tray 205 may be removed and contents disposed of as needed. However, in another embodiment, drainage tray may be coupled to a wastewater collection reservoir (not expressly shown) for proper disposal of contaminated wastewater or biohazardous materials.

Portable cleaning system 200 also includes caster wheels 206 coupled to bottom of housing 201 allowing portable cleaning system 200 to be easily moved, or stored as needed. In one form, caster wheels 206 may include a locking mechanism, allowing system 200 to remain stationary during use and/or storage.

Internal spray system 203 includes a manifold 207 having plural spray nozzles 202 located along the top, bottom, and both sides of housing 201 and may be formed from various types of plumbing materials such as plastic, PVC, aluminum, etc. A connector 208 allows for connection of to a source. Portable cleaning system 200 further includes a connector 208 which may include a quick disconnect connector (not expressly shown) to allow for efficient connection and disconnection of a fluid distribution line (not expressly shown). In one embodiment, internal spray system 203 may be used with low-pressure fluid distribution line 101 of FIG. 1 to supply a cleansing agent. In another embodiment, internal spray system 203 may be used with high-pressure fluid distribution line 102 of FIG. 1. Various other types of fluid distribution systems may also be used. Additionally, various types of fluids may be used with internal spray system 203 including, but not limited to, cleansing agents, rinse water, sanitizing agents, polish or waxing agents, or various other types of liquids as needed. Manifold 207 also includes several spray nozzles 202 positioned within housing 201 and operable to produce a three hundred sixty degree (360) washing of a cart and evenly distributes water to each spray nozzle 202. In one form, each spray nozzle may be unidirectional (i.e. capable of spraying in a single direction) however, in other embodiment, multi-directional spray nozzles may be used.

During use, a user couples a fluid distribution line to connector 208 and an object to be cleansed, such as a cart is placed within housing 201 of portable cleaning apparatus 200. As a cart approaches internal spray system 203 positioned along housing 201, manifold 207 may be charged with a fluid and spay nozzles 202 may spray a cart along a three hundred sixty (360) degree radius. For example, a user may manually activate a valve to charge manifold 207 or manifold 207 may be automatically charged using a control valve or solenoid operable to activate a valve associated with manifold 207 to charge manifold 207. For example, portable cleaning system 200 may include a sensor, such as a weight sensor, optical sensor, feeler type sensor, or any other type of sensor operable to sense if a cart is approaching a stage within portable cleaning system 200 employing internal spray system 203. A control circuit may be connected to the sensor and operable to activate a solenoid to open a valve to charge manifold 207 and distribute a liquid. As a cart passes internal spray system 203, a user may manually deactivate a valve to turn off internal spray system 203. In another embodiment, a programmable timing circuit may be used to activate and deactivate internal spray system 203. Internal spray system 203 may then remain in an idle state until a user charges manifold 207 or manifold 207 is automatically charged if a automated system is employed.

Note that although an embodiment of the invention has been shown and described in detail herein, along with certain variants thereof, many other varied embodiments that incorporate the teachings of the invention may be easily constructed by those skilled in the art. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. Accordingly, the invention is not intended to be limited to the specific form set forth herein, but on the contrary, it is intended to cover such alternatives, modifications, and equivalents, as can be reasonably included within the spirit and scope of the invention.

What is claimed is:

1. A portable cleaning system comprising:
an elongated housing including openings at non-contiguous opposing ends;
an internal spray system operable to spray contents placed within the housing along a three hundred and sixty (360) degree radius at multiple stages within the housing;
a plurality of elongated pieces of material hung vertically and substantially covering the non-contiguous opposing ends, the plurality of elongated pieces of material operable to reduce an over spray from exiting the housing; and
an automated transfer system operable to transfer a plurality of carts along the length of the housing.

2. The portable cleaning system of claim 1, further comprising a low-pressure fluid distribution line operable to supply a cleansing agent to one of the multiple stages.

3. The portable cleaning system of claim 1, further comprising a high-pressure fluid distribution line connected to the housing and operable to supply a rinse agent along to one of the multiple stages located along a center portion of the rectangular housing.

4. The portable cleaning system of claim 3, further comprising the low-pressure fluid distribution line connected to the housing and operable to supply a sanitizing agent to one of the multiple stages located along a rear portion of the housing.

5. The portable cleaning system of claim 1, further comprising a dry air port coupled along a rear portion of the housing and operable to provide dry air to dry contents when placed near the dry air port.

6. The portable cleaning system of claim 1, wherein the automated transport system includes:
a cart transport system operable to transfer a plurality of carts from an entry of the housing to and exit of the housing; and
a plurality of stage sensors operable to detect a position of at least one cart along the housing and to activate a process based on the relative position of the cart.

7. The portable cleaning system of claim 6, further comprising at least one process of a wash process, a rinse process, a sanitize process, and a dry process.

8. The portable cleaning system of claim 1 wherein the housing comprises metal.

9. The portable cleaning system of claim 1, wherein the housing comprises a polycarbonate material.

10. The portable cleaning system of claim 1, wherein the automated transfer system includes a computerized belt driven transfer system operable to activate a belt transfer to transfer at least one cart to a stage and a stage sensor operable to detect when the cart is positioned at the stage and to activate a process associated with the stage.

11. The portable cleaning system of claim 10, wherein the automated transfer system includes a control circuit operably coupled to each stage and operable to activate one or more solenoids associated with enabling a portion of the internal spray system.

12. The portable cleaning system of claim 1, further comprising the housing including a length operable to house and simultaneously process multiple shopping carts.

13. A portable cleaning system comprising:
a housing including a length and a first and second openings at non-contiguous opposing ends;
a high-pressure internal spray system operable to spray contents placed along a first stage within the housing, the high-pressure internal spray system operable to spray along a three hundred and sixty (360) degree radius;
a low-pressure internal spray system operable to spray contents placed at a second stage within the housing, the high-pressure internal spray system operable to spray along a three hundred and sixty (360) degree radius; and
a cart transport system including a front loading platform, a rear unloading platform, and a track there between, the cart transport system operable to transfer a plurality of carts along the housing.

14. The portable cleaning system of claim 11, wherein the high-pressure internal spray system includes a high-pressure manifold positioned along a front portion of the housing, the high low-pressure manifold coupled to a high-pressure release valve operable to releasably couple the high-pressure manifold to a rinse supply line.

15. The portable cleaning system of claim 13, wherein the low-pressure internal spray system includes:
a first low-pressure manifold positioned along a front portion of the housing, the first low-pressure manifold coupled to a low-pressure release valve operable to releasably couple the first low-pressure manifold to a cleaning agent supply line; and
a second low-pressure manifold positioned along a rear portion of the housing, the second low-pressure manifold coupled to a low-pressure release valve operable to releasably couple the second low-pressure manifold to a sanitizing agent supply line.

16. The portable cleaning system of claim 14, wherein the high-pressure manifold, the first low-pressure manifold, and the second low-pressure manifold include spray nozzles positioned along a top portion, a bottom portion, and side portions of the housing.

17. The portable cleaning system of claim 11, further comprising a drainage tray positioned along an undercarriage of the housing and extending along a portion of the length and width of the housing and operable to capture waste draining from the housing.

18. The portable cleaning system of claim 11, further comprising a removable drainage tray.

19. A portable cleaning system comprising:
a rectangular housing enclosed along four contiguous sides including a first opening providing an entry and a second opening providing an exit;
a high-pressure internal spray system operable to spray contents placed within the housing along a three hundred and sixty (360) degree radius;
a low-pressure internal spray system operable to spray contents placed within the housing along a three hundred and sixty (360) degree radius;
a loading platform coupled to the entry and operable to assist with loading a plurality of carts into the housing;
an exit platform coupled to the exit and operable to assist with unloading the plurality of carts from the housing; and
two (2) tracks running along a bottom of the housing and extending from the entry to the exit, the two (2) tracks including a portion of the low-pressure internal spray system and the high-pressure internal spray system positioned between the two (2) tracks.

20. The portable cleaning system of claim 18, further comprising a plurality of elongated pieces of material hung vertically along the entry and the exit and substantially covering the entry and exit to reduce an over spray from exiting the housing.

21. The portable cleaning system of claim 18, wherein the cleaning apparatus further includes:
a first low-pressure manifold coupled to an interior of the housing and located approximately toward a front portion of the housing and operable to provide a cleaning agent;
a high-pressure manifold coupled to an interior of the housing and located approximately toward a middle portion of the rectangular housing and operable to provide a high pressure rinse;
a second low-pressure manifold coupled to an interior of the housing and located approximately toward a rear portion of the rectangular housing and operable to provide a sanitization agent; and
a vacuum port coupled to an interior of the housing and located approximately toward a rear portion of the rectangular housing and operable to blow air along the rear portion of the rectangular housing.
